(19) United States
(12) Patent Application Publication
(10) Pub. No.: US 2023/0163599 A1
(43) Pub. Date: May 25, 2023

(54) OFFSHORE POWER TRANSMISSION AND DISTRIBUTION NETWORK

(71) Applicant: Chevron U.S.A. Inc., San Ramon, CA (US)

(72) Inventors: Gregory J. Clement, Sugar Land, TX (US); Richard S. Kopps, Sugar Land, TX (US)

(21) Appl. No.: 18/057,635

(22) Filed: Nov. 21, 2022

Related U.S. Application Data
(60) Provisional application No. 63/281,457, filed on Nov. 19, 2021.

(51) Int. Cl. H02J 3/38

(52) U.S. Cl. CPC H02J 3/381; H02J 2300/28

(57) ABSTRACT

Systems and methods for power distribution may include a plurality of generation, distribution, and load nodes. A first generation node generates and transmits power to a first distribution node via a first transmission type, the first transmission type including MVDC or HVDC or LFAC. A second generation node generates and transmits power to a second distribution node via a second transmission type including HVAC. The first distribution node distributes the power to a first load node via the second transmission type, and distributes the power to a second load node via a third transmission type, the third transmission type including MVAC. The first load node transmits the power to a first subsea facility via one or more flow lines and the third transmission type. The second load node transmits the power to a second subsea facility via the one or more flow lines and the third transmission type.

### CROSS-REFERENCE TO RELATED APPLICATION

This application claims the benefit of U.S. Provisional Patent Application No. 63/281,457, filed Nov. 19, 2021, which is incorporated by reference herein in its entirety.

### FIELD OF THE DISCLOSURE

The present disclosure relates to systems and methods for offshore power transmission and distribution networks.

### BACKGROUND

Although onshore power transmission is known, offshore power transmission poses different challenges due to the installation, operation, and efficiency in a subsea environment.

These and other deficiencies exist.

### SUMMARY OF THE DISCLOSURE

Embodiments of the present disclosure provide a power distribution system. The power distribution system may include a plurality of generation nodes; a plurality of distribution nodes; and a plurality of load nodes. A first generation node may be configured to generate and transmit power to a first distribution node via a first transmission type, the first transmission type including medium voltage direct current (MVDC) or high voltage direct current (HVDC) or low frequency alternating current (LFAC). A second generation node may be configured to generate and transmit power to a second distribution node via a second transmission type, the second transmission type including high voltage alternating current (HVAC). The first distribution node may be configured to distribute the power to a first load node via the second transmission type, and distribute the power to a second load node via a third transmission type, the third transmission type including medium voltage alternating current (MVAC). The first load node may be configured to transmit the power to a first subsea facility via one or more flow lines and the third transmission type. The second load node may be configured to transmit the power to a second subsea facility via the one or more flow lines and the third transmission type.

Embodiments of the present disclosure provide a power distribution system. The power distribution system may include a plurality of generation nodes; a plurality of distribution nodes; and a plurality of load nodes. A first generation node may be configured to generate and transmit power to a first distribution node via a first transmission type, the first transmission type including MVDC or HVDC. A second generation node may be configured to generate and transmit power to a second distribution node via the first transmission type. The first distribution node may be configured to distribute the power to a first distribution load node via a second transmission type, the second transmission type include HVAC. The second distribution node may be configured to distribute the power to a second distribution load node via the second transmission type. The first distribution load node may be configured to transmit the power to a plurality of load nodes. The second distribution load note may be configured to transmit the power to a third load node.

Embodiments of the present disclosure provide a power distribution system. The power distribution system may include a plurality of generation nodes, distribution notes, and load nodes. A first generation node may be configured to generate and transmit power to a first distribution node via a first transmission type, the first transmission type including HVAC. A second generation node may be configured to generate and transmit power to the first distribution node via a second transmission type, the second transmission type including MVDC or HVDC. A third generation node may be configured to generate and transmit power to a second distribution node via the second transmission type. The first distribution node may be configured to distribute the power to a first load node. The second distribution node may be configured to distribute the power to two or more additional load nodes.

Embodiments of the present disclosure provide a power distribution system. The power distribution system may include a generation node a load node. The generation node may be configured to generate and transmit power to the load node by a first transmission type including HVAC via a subsea electrical distribution system.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts an embodiment of a power distribution system according to an aspect of this disclosure.

FIG. 2 depicts a power distribution system according to an example embodiment.

FIG. 3 depicts a power distribution system according to an example embodiment.

FIG. 4 depicts a power distribution system according to an example embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The systems and methods disclosed herein transmit high power from onshore generation stations to deep water offshore facilities or between a plurality of deep water offshore facilities. Although subsea power transmission architecture has been studied to solve specific challenges, there is not a viable solution to distribute and transmit large quantities of power over long distances in deep water to a plurality of consumers. To address these and/or other challenges, the systems and methods disclosed herein include offshore power transmission and distribution networks to deliver electrical power to offshore consumers. Among other advantages, the disclosed embodiments may reduce a need for power generation on electrical topsides, allow longer subsea tiebacks to access stranded oil, and allow power to be shared between one or more assets.

The systems and methods disclosed herein may utilize a variety of types of nodes, which may generally refer to a variety of different types of facilities where electrical power may be generated, stored, transformed, distributed, or used to power a load. Without limitation, these nodes may include generation nodes, distribution nodes, load nodes, and/or any combination thereof, as explained below.

In some examples, one or more generation nodes may be configured to serve as a source of power for the transmission network. For example, the generation node may include an onshore power plant, jacket on the shelf with power, offshore gas turbine generators, a wind turbine, and so on.

In some examples, one or more distribution nodes may be configured to receive power from one or more generation nodes and distribute the power to one or more other distribution nodes and/or one or more load nodes. For example, the distribution node may include a substation, such as a transmission substation, a switching station, or a collector substation. In some examples, the distribution node may also serve as a load node.

In some examples, one or more load nodes may include or be associated with one or more consumers, such as a group of consumers, of electrical power. For example, the load node may comprise a motor or transformer, such as a stepdown transform, at an electrical distribution substation or subsea power grid. The load node may include, for instance, subsea equipment and/or equipment located on an offshore platform (e.g., topsides equipment).

In some examples, high voltage AC (HVAC) power transmission is utilized from a facility to a grid. In some examples, the facility may comprise a remote facility. In some examples, the grid may comprise a subsea power grid including one or more transformers, switchgear, and/or any combination thereof. The power may be routed to subsea electrical power consumers and/or an electrical topside. Although power may be transferred via HVAC, there is a point or threshold distance at which transfer of the power via AC is not feasible or not possible. At or before this point, in which the switch is made to HVDC, and all or nearly all of the diameter of the conductor is thus utilized. In this manner, bulk amounts of power may be transmitted for distribution at long distances.

In some examples, a combination of high voltage DC (HVDC) power transmission, HVAC, medium voltage (MVAC), and/or low frequency AC (LFAC) may be configured to transmit a large quantity of electrical power from a first facility to one or more second facilities. For example, the first facility may comprise a remote facility. In some examples, at least one of the second facilities may comprise an offshore electrical topside facility. In other examples, the one or more second facilities may comprise a plurality of offshore electrical topside facilities. Power may be inverted to MVAC for local or remote use, or HVAC where it may be supplied to an offshore electrical hub either subsea or topside where it may be stepped down in voltage and further distributed to consumers.

For the following systems, numerous power transmissions for various ranges of parameters for feeds may be used. For MVDC or HVDC, this may include 120 MW and extend about <300 km and 250 MW and extend about 500 km-600 km, respectively. For LFAC, this may include about 50 MW and 300 km-600 km. For HVAC, this may include about 30 MW-80 MW and extend about >200 km. For MVAC, this may include about 33 kV. In addition, various direct electrical heating cables (DEH) and flow lines may be utilized.

As noted, the present disclosure includes embodiments of offshore power transmission and distribution networks to deliver electrical power to offshore consumers. In one embodiment, an offshore power transmission and distribution network utilizes HVAC power transmission from a remote facility to a subsea power grid, which may include a subsea step-down transformer and subsea switchgear. The power can then be routed to subsea electrical power consumers and/or an electrical topside. In another embodiment, an offshore power transmission and distribution network utilizes a combination of HVDC power transmission from a remote facility or multiple facilities and HVAC, MVAC and/or LFAC to transmit a large quantity of electrical power to an offshore topside facility. Power is then inverted to MVAC for local or remote use or HVAC where it can then be supplied to offshore electrical hub either subsea or topside where it can be stepped down in voltage and further distributed to consumers. Examples of such embodiments are described in further detail herein.

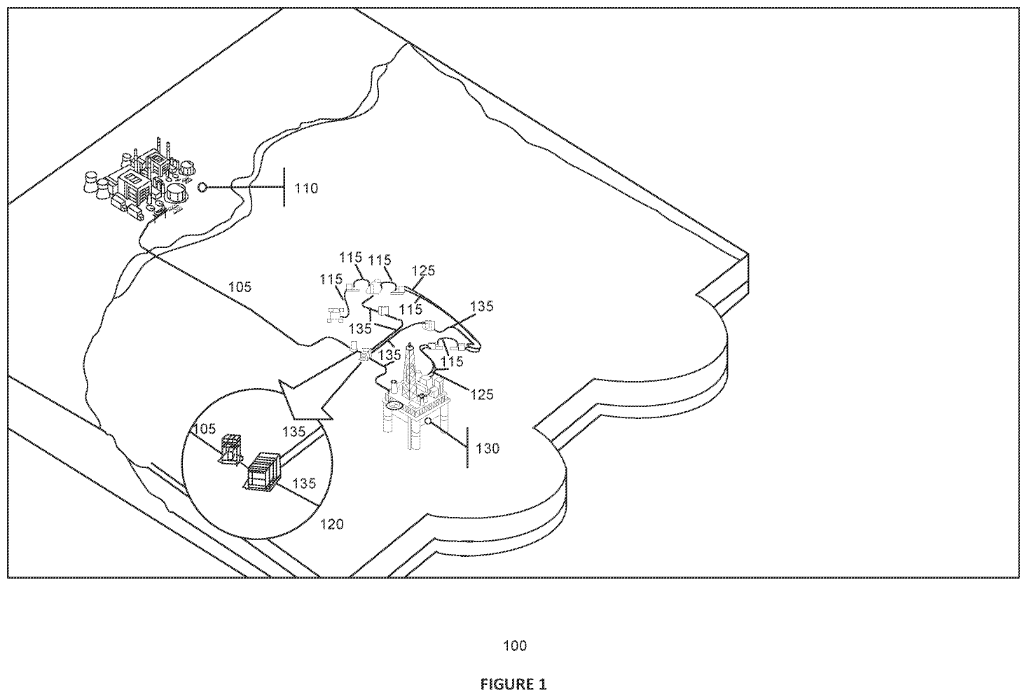

FIG. 1 illustrates a power distribution system according to an example embodiment in which HVAC is used for initial transmission from an onshore power generation facility. The first system may comprise a first network. The first network may include a radial network 100. For example, the radial network may include a generation node 110, a distribution system 120, and a load node 130. It is understood that although single instances of components of network 100 may be depicted, network 100 may include any number of components.

The generation node 110 may include a power source generation node, including but not limited to renewables or a power plant. The power source generation node may be located onshore. In addition, the radial network may include a cable 105 (a feed 105), such as an HVAC cable that may terminate at a transformer. The power may be transmitted from the generation node 110 to the distribution system 120, such as a subsea electrical distribution system and supply power to various features, such as a topside of an offshore platform. In some examples, the distribution system 120 may include any number of transformers, boosting pumps, and/or compressors. In addition, the radial network 100 may utilize one or more feed lines between the generation node 110 and the load node 130. The feed 105 from the generation node 110 to the subsea electrical distribution system 120 may be via HVAC to distribute the power to the load node 130. Various flow lines 115 and DEH cables 125 and MVAC 135 may be used to tie the distribution system 120 and load node 130. In an embodiment, the subsea electrical distribution system 120 may include one or more transformers to step the voltage down from high voltage to medium voltage for use by the subsea equipment and the illustrated platform.

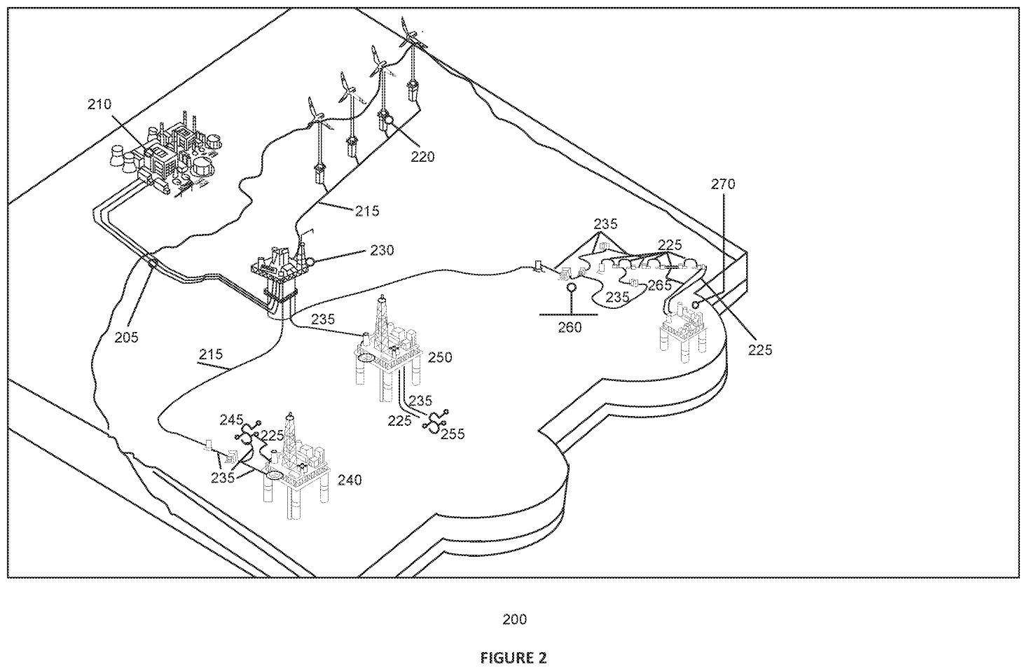

FIG. 2 illustrates a power distribution system according to an example embodiment. The second system may comprise a second network. The second network may include a bulk power radial hub network 200. For example, the bulk power radial hub network 200 may include one or more generation nodes, distribution nodes, and load nodes. It is understood that although single instances of components of network 200 may be depicted, network 200 may include any number of components and include or reference any component of network 100 of FIG. 1.

As illustrated in FIG. 2, a first generation node 210 may comprise an onshore power generation node. A second generation node 220 may be configured to provide supplemental power from an additional source, for instance offshore power generation features which may include but are not limited to a wind turbine. In some examples, the wind turbine may be part of a wind farm. Without limitation, the feed 205 from the first generation node 210 to the distribution node 230 may be via DC, HVAC, or LFAC. Without limitation, the feed 215 from the second generation node 220 to the distribution node 230 may be via HVAC. Power may be distributed to a subsea system from the distribution node 230. The distribution node 230 may distribute the power to various load nodes 240, 250 via feeds. For example, the distribution node 230 may distribute power to a first load node 240 via HVAC 215. The distribution node 230 may also distribute power to a second load node 250 via MVAC 235. In some examples, the load nodes may be tied to respective subsea systems for power supply thereto. For example, the first load node 240 may be tied to a first subsea system 245 via flow line 225, and the second load node 250 may be tied to a second subsea system 255 via flow line 225. The distribution node 230 may also distribute power to a third load node 260 via HVAC 215. In addition, an existing platform 270 with limited spinning reserve may be configured to receive the distributed power through the third load node via MVAC. That is, one of the load nodes 260 may be tied to the existing platform 270 via MVAC 235. In addition, various flow lines 225 and DEH cables 265 may be used.

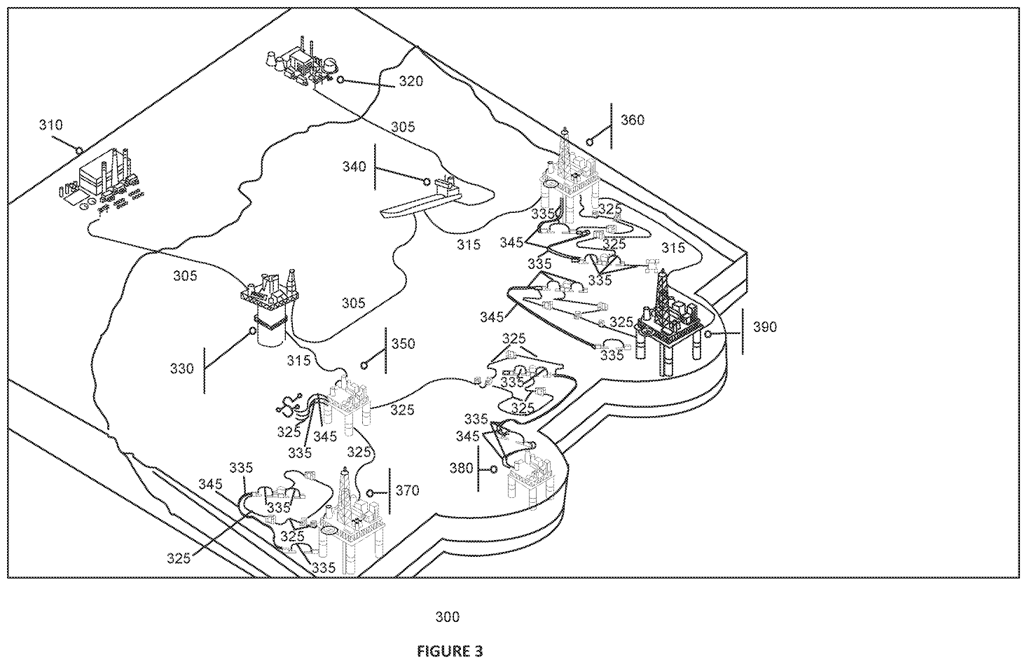

FIG. 3 illustrates a power distribution system according to an example embodiment. The third system may comprise a third network. The third network may include a bulk power ring network 300. For example, the bulk power ring network 300 may include one or more generation nodes, distribution nodes, and load nodes. It is understood that although single instances of components of network 300 may be depicted, network 300 may include any number of components and include or reference any component of network 100 of FIG. 1, and network 200 of FIG. 2.

In some embodiments, the system may include multiple generation nodes 310, 320 located onshore. The onshore generation nodes 310, 320 may have similar configurations or different configurations (e.g., the same fuel sources or different fuel sources). The feed 305 for power from the first generation node 310 to a first distribution node 330 may be via MVDC or HVDC. The first distribution node 330 may comprise an unmanned platform or facility configured to distribute and deliver power to other nodes. The feed 305 from the second generation node 320 to a second distribution node 340 may be MVDC or HVDC. Feed 305 may be used to tie first distribution node 330 to second distribution node 340 (e.g., an offshore transport). For example, each of the first and second distribution nodes 330, 340 may be tied to each other via MVDC or HVDC 305, and also tied to distribution and load nodes 350, 360. For example, the first distribution node 330 may feed power to a first distribution and load node 350 via HVAC 315. The second distribution node 340 may feed power to a second distribution and load node 360 via HVAC 315. Each of the distribution and load nodes 350, 360 may be configured to distribute power to various load nodes 370, 380, 390. For example, the first distribution and load node 350 may distribute power to a first load node 370 and a second load node 380 via MVAC 325. The second distribution and load node 360 may be tied to the third load node 370 via various feeds. In addition, various flow lines 335 and DEH cables 345 may be used.

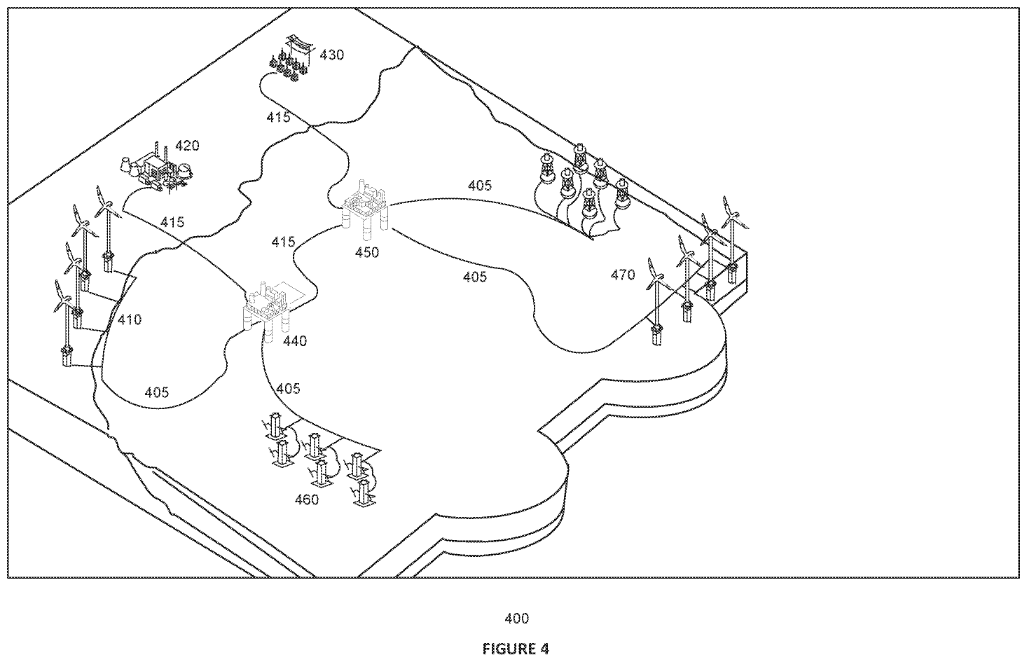

FIG. 4 illustrates a power distribution system according to an example embodiment. This system may comprise a network 400. The network 400 may include one or more generation nodes, distribution nodes, and load nodes. It is understood that although single instances of components of network 400 may be depicted, network 400 may include any number of components and include or reference any component of network 100 of FIG. 1, network 200 of FIG. 2, and network 300 of FIG. 3.

For example, a first generation node 410 may comprise one or more turbines. The first generation node 410 and a second generation node 420 may be tied to a first distribution node 440. For example, the first generation node 410 may be tied to the first distribution node 440 via HVAC feed 405. The second generation node 420 may be tied to the first distribution node 440 via MVDC or HVDC feed 415. The third generation node 430 may be tied to a second distribution node 450 via MVDC or HVDC 415. The first and second distribution nodes 440, 450 may be tied via MVDC or HVDC 415. The first distribution node 440 may be configured to distribute power to a first load node 460 via HVAC 405. The second distribution node 450 may be configured to distribute power to a second load node 470 via HVAC 405. In this manner, the flexibility of the power generation and distribution of the network 400 is shown, and as such is not limited to power from a source on shore such as the beach but rather may be derived from an existing refinery or similar asset located on shore. In addition, renewable may derive power from any number of sources, including but not limited to wind, solar, etc.

For any of the above systems, a plurality of categories of components may be utilized, in any number and in any combination. For example, the plurality of categories of components may include cable, topside equipment, and subsea equipment. The cables may include static and dynamic cables, and/or any combination thereof. The topside equipment may include a transformer, a frequency converter, a shunt reactor, and/or any combination thereof. The subsea equipment may include a transformer, a frequency converter, a shunt reactor, an adjustable speed drive, a wet mate connector, and/or any combination thereof. For MVAC operation, such as <69 kV, the depth of operation subsea for each of the static and dynamic cables may extend to at least 3000 m, topside equipment may include any combination of a transformer, a frequency converter, a shunt reactor, and the subsea equipment may include a transformer, ASD, and a wet mate connector. For HVAC operation, such as >69 kV, the depth of operation subsea for the static cable may extend to at least 3000 m, topside equipment may include any combination of a transformer, a frequency converter, a shunt reactor, and subsea equipment may include a transformer. For LFAC operation, the depth of operation subsea for the static cable may extend to at least 3000 m, topside equipment may include any combination of a transformer, a frequency converter, a shunt reactor, and the subsea equipment may include a ASD configured to operated at a low frequency. For HVDC operation, the topside equipment may include a transformer and a shunt reactor.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A power distribution system, comprising:
a first generation node configured to generate and transmit power to a first distribution node via a first transmission type, the first transmission type including MVDC or HVDC or LFAC; and
a second generation node configured to generate and transmit power to a second distribution node via a second transmission type, the second transmission type including HVAC;
wherein the first distribution node is configured to distribute the power to a first load node via the second transmission type, and distribute the power to a second load node via a third transmission type, the third transmission type including MVAC;
wherein the first load node is configured to transmit the power to a first subsea facility via one or more flow lines and the third transmission type; and
wherein the second load node is configured to transmit the power to a second subsea facility via the one or more flow lines and the third transmission type.

2. The power distribution system of claim 1, wherein the second distribution node is configured to distribute the power to a third load node via the second transmission type.

3. The power distribution system of claim 2, wherein the third load node is configured to transmit the power to an existing platform.

4. The power distribution system of claim 3, wherein the power is transmitted from the third load node to the existing platform via the third transmission type, one or more flow lines, and one or more cables.

5. The power distribution system of claim 3, wherein the existing platform includes a limited spinning reserve.

6. The power distribution system of claim 1, wherein the first generation node is located onshore.

7. The power distribution system of claim 1, wherein the second generation node comprises a supplemental power source.

8. A power distribution system comprising:
a first generation node configured to generate and transmit power to a first distribution node via a first transmission type, the first transmission type including MVDC or HVDC;
a second generation node configured to generate and transmit power to a second distribution node via the first transmission type;
wherein the first distribution node is configured to distribute the power to a first distribution load node via a second transmission type, the second transmission type including HVAC;
wherein the second distribution node is configured to distribute the power to a second distribution load node via the second transmission type;
wherein the first distribution load node is configured to transmit the power to a plurality of load nodes; and
wherein the second distribution load node is configured to transmit the power to a third load node.

9. The power distribution system of claim 8, wherein the first distribution load node is configured to distribute power to plurality of load nodes via a third transmission type, the third transmission type include MVAC.

10. The power distribution system of claim 8, wherein the second distribution load node is configured to distribute power to the third load node via a third transmission type.

11. The power distribution system of claim 10, wherein the third transmission type includes MVAC.

12. The power distribution system of claim 8, wherein the power transmitted to the plurality of load nodes is via one or more flow lines, and one or more cables.

13. The power distribution system of claim 8, wherein the power transmitted to the third load node is via one or more flow lines, and one or more cables.

14. The power distribution system of claim 8, wherein the first generation node and the second generation node are located on shore.

15. The power distribution system of claim 8, wherein the second distribution load node is configured to distribute the power to the third load node via the second transmission type.

16. A power distribution system comprising:
a first generation node configured to generate and transmit power to a first distribution node via a first transmission type, the first transmission type including HVAC; and
a second generation node configured to generate and transmit power to the first distribution node via a second transmission type, the second transmission type including MVDC or HVDC;
a third generation node configured to generate and transmit power to a second distribution node via the second transmission type;
wherein the first distribution node is configured to distribute the power to a first load node; and
wherein the second distribution node is configured to distribute the power to two or more additional load nodes.

17. The power distribution system of claim 16, wherein the power distributed from the first distribution node to the first load node is via the first transmission type.

18. The power distribution system of claim 16, wherein the power distributed from the second distribution node to the two or more additional load nodes via the first transmission type.

19. The power distribution system of claim 16, wherein the first distribution node is configured to transmit the power to the second distribution node via the second transmission type.

20. A power distribution system comprising:
a generation node; and
a load node connected to the generation node; and
wherein the generation node is configured to generate and transmit power to the load node by a first transmission type including HVAC via a subsea electrical distribution system.
